(19) United States
(12) Patent Application Publication
(10) Pub. No.: US 2015/0178341 A1
(43) Pub. Date: Jun. 25, 2015

(54) APPLICATION EVALUATION

(71) Applicant: Google Inc., Mountain View, CA (US)

(72) Inventors: Atul Kumar, Palo Alto, CA (US); Hsu-Chieh Lee, Mountain View, CA (US); Sheng Chi Hsieh, Mountain View, CA (US)

(73) Assignee: Google Inc., Mountain View, CA (US)

(21) Appl. No.: 14/135,906

(22) Filed: Dec. 20, 2013

(51) Int. Cl. G06F 17/30

(52) U.S. Cl. CPC G06F 17/30342; G06F 17/30598

(57) ABSTRACT

Systems and techniques are disclosed for receiving an application submitted to an application market and determining a global rank for the application based at least on a visibility rank and a risk rank. The visibility rank may be determined based on observed visibility, a probabilistic visibility, and/or an externality. The application may be placed in a review category based on the global rank. Additionally, an application priority category may be associated with the application based on the global rank.

### BACKGROUND

Traditionally, applications submitted to an online application marketplace are reviewed prior to being published to the public. For example, a developer may submit an application to an online application market and the submitted application may be reviewed manually prior to being released to the public such that a user may access and download the application via a user device. Furthermore, generally, an application submitted to an online application market is reviewed in the order it is received such that a first application provided to the online application market at a first time will be reviewed prior to a second application that is also submitted to the online application market at a second, subsequent, time. The review and/or delay in review time may insert an unacceptable delay into the application publication process.

### BRIEF SUMMARY

According to implementations of the disclosed subject matter, an application may be received at an application market. A global rank may be determined for the application such that the global rank is based on at least a visibility rank and a risk rank. The visibility rank may correspond to the probability of application being exposed to the user and may be based on an observed visibility, a probabilistic visibility, and/or an externality. The risk rank may be based on a user input, a profanity rating, a content maturity rating, an incompatibility rating, a secrecy rating, an automatically generated block, and/or a user provided block. The application may be placed in a review category based on the global rank. The review category may be a null action or an application flag (e.g., a removal of the application, applying a functionality test, applying a quality test, etc.) The global rank may be updated such that a change in either visibility rank or risk rank may result in a change in the global rank. A resource may be allocated to the global rank and may correspond to a time range. The global rank may be updated and a change between the global rank at a first time and a subsequent second time may be determined. The resource may be allocated based a buffer threshold.

Systems and techniques according to the present disclosure enable placement of an application in a review category based on factors such as a visibility rank and a risk rank. Additional characteristics, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows an example process of placing an application in a review category, according to an implementation of the disclosed subject matter.

FIG. 4 shows an example illustration of prioritized categories for applications, according to an implementation of the disclosed subject matter.

FIG. 5 shows an example illustration a dynamic global rank, according to an implementation of the disclosed subject matter.

### DETAILED DESCRIPTION

Techniques and systems described herein can be applied to place applications received at a market place into one or more review categories. Applications received at an online application market place may be provided to one or more users (e.g., the general public, a beta group of users, a specific group of users, etc.) based on the review category corresponding to the application. As an example, if the review category corresponding to an application is a null action then the application may be provided to the general public. Alternatively, if the review category corresponding to an application is an application flag, then the application may not be provided to the general public and may either be removed from the application store, be marked for a functionality test, be marked for a quality test, or the like. An application may be placed in a review category based on a global rank associated with the application. A global rank may be based at least on a visibility rank and a risk rank. A visibility rank may correspond to the probability of application being exposed to the user and may be based on an observed visibility, a probabilistic visibility, and/or an externality, as disclosed herein. A risk rank may be based on a user input, a profanity rating, a content maturity rating, an incompatibility rating, a secrecy rating, an automatically generated block, and/or a user provided block, as disclosed herein. Notably, based on the techniques disclosed herein, an application that is highly visible to the public or a portion of the public is more likely to be placed in a more stringent review category whereas an application that is not very visible to the public or a portion of the public is more likely to be placed in a less stringent review category. Additionally, an application that carries a higher risk of being unsuitable for an online application market is more likely to be placed in a more stringent review category whereas an application that is suitable for an online application market is more likely to be placed in a less stringent review category. This arrangement can allow for an open ecosystem that enables more efficient publishing of applications such that more risky and/or more visible applications are placed into a more stringent review category and less risky and/or visible applications are placed in a less stringent review category. As an example, an application that is at a high risk such that it is likely to be unsuitable for an application market may not be more urgently reviewed if it is likely that the high risk application will not be visible to the public.

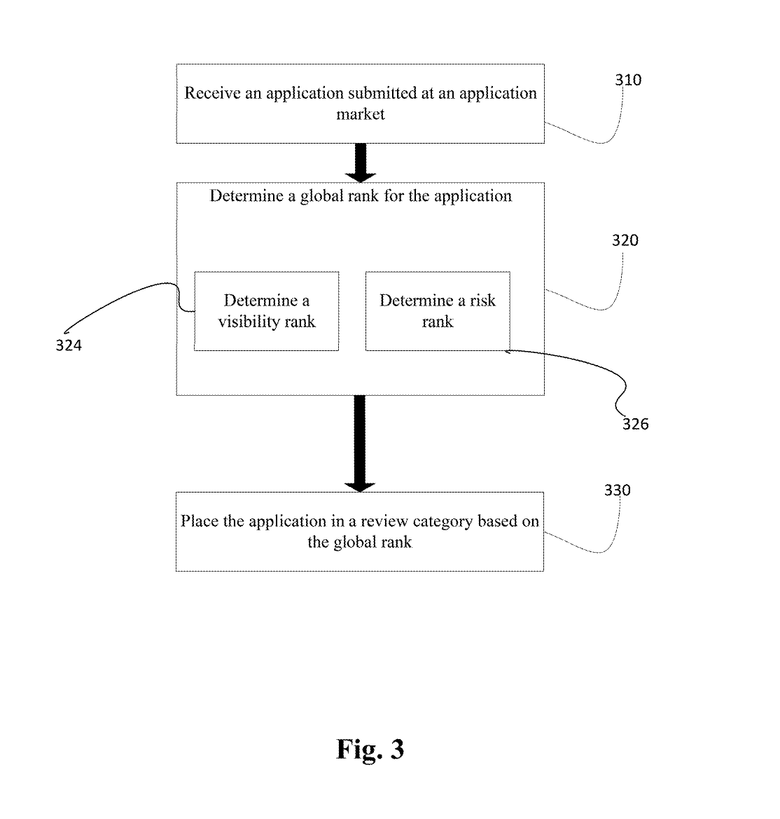

According to implementations of the disclosed subject matter, as shown in FIG. 3, at 310, an application or an update to an existing application (recited herein as, “application”) may be received at an application market. The application may be submitted to the application market by a developer. The developer may be an individual user, a company, a user group, or the like. For example, an application may be submitted via an account that is associated with an individual user. Alternatively, an application may be submitted via an account that is associated with a company C. Account information regarding the account via which an application is submitted may be associated with the submitted application. The account information may be a factor when determining a visibility rank and/or risk rank associated with the application, as disclosed herein. An application may be submitted in any applicable manner such as by uploading files associated with the application to an application market using a user device, uploading application files associated with the application to a server or database associated with the application market, or the like. A user may provide application information regarding a submitted application when uploading the application. The application information may be information associated with the application such as an application title, application category, application theme, intended application user base, application cost, or the like. As an example, a developer submitting a gaming application my upload the gaming application to the application market via a computer. The developer may provide application information that includes the application being a gaming application, corresponding to sports, intended for a certain demographic and costing $0.99.

At 320 in FIG. 3, a global rank may be determined for the submitted application. The global rank may be based at least on a determined visibility rank, at 324, and a risk rank, at 326. The global rank may be a function of the visibility rank and risk rank such that:

Global rank=f(visibility rank, risk rank)

A global rank may be calculated for all or a subset of all submitted applications.

According to an implementation of the disclosed subject matter, an application may not be published to an online application market if an initial global rank meets or exceeds a minimum global rank threshold. An initial global rank may be determined based on the available information associated with the application when the application is submitted to the online application market (e.g., the information submitted by a developer, information gathered from a scan of the application code, a simulation of the application, etc.). Essentially, an application may be required to be validated by the arrangement prior to being provided to the public or a subset of the public. The minimum global rank threshold may be predetermined such that it is an established minimum global rank threshold (e.g., 20). Alternatively, a minimum global rank threshold may be determined based on an average global rank associated with all or a subset of application either currently available via the online application market or submitted to the online application market within a given amount of time. An initial global rank threshold may be based on a risk rank and a visibility rank associated with an application when the application is submitted to the online application market. The initial risk rank and/or visibility rank may be calculated according to techniques disclosed herein. It will be understood that although a global rank is described such that a higher global rank results in a more stringent review category, the implementations disclosed herein may be applied such that a lower global rank results in a more stringent review category. As an example, instead of a minimum global rank threshold, an application may not be published to an online application market if an initial global rank is below a maximum global rank threshold (e.g., 80).

Alternatively, according to an implementation of the disclosed subject matter, each submitted application may be provided to an online application market when the application is submitted to the online application market. Essentially, an application may not be required to be validated by the arrangement prior to being provided to the public or a subset of the public. For example, an application may be available to the public when the application is submitted to an online application market by a developer. Initially providing an application submitted to an online application market may provide a scalable way of maintaining an open ecosystem for application publishing without incurring unsustainable resource cost and long delays, as disclosed herein. The application may, by default, be placed into a null action review category such that no review is required for the application. Alternatively or in addition, the resources allocated to a submitted application may, by default, correspond to a low priority, as disclosed herein. Subsequently, the global rank associated with the application may be determined or modified and the determined or modified global rank may result in placing the application in a different review category and/or the resources allocated to the submitted application may correspond to a high priority categorization.

According to an implementation of the disclosed subject matter, a visibility rank associated with a submitted application may be calculated. It will be understood that the visibility rank corresponding to a submitted application may be calculated for any amount of time after the application has been submitted. For example, visibility rank may be calculated for an application a year after the application was initially submitted to an online application market. A visibility rank may correspond to a probability distribution of how likely a user is to gain access to the application. Access to an application may be any applicable exposure to the application such as viewing the application in an online application market, discovering the application at a third party outlet, downloading the application, installing the application, or the like. The visibility rank of an application may be based on one or more of an observed visibility of the application, a probabilistic visibility of the application, or visibility of the application induced by externalities.

According to an implementation of the disclosed subject matter, an observed visibility of an application may correspond to actual exposure of the application by the public or a subset of the public. The observed visibility may be detected based on exposure of the application via an online application market and/or via a third party outlet such as a media outlet (e.g., news media outlet, aggregation outlet, entertainment media outlet, social media outlet, educational media outlet, etc.). The observed visibility of an application may be calculated based on any exposure such as an impression (e.g., selection of the application for view in an online application market, installation of the application, use of the application once the application has been installed on a user device, etc.), a velocity associated with the application (e.g., a change in frequency of selection of the application for view in an online application market, change in frequency of installation of the application, change in frequency of use of installed instances of the application, etc.), a user rating associated with the application (e.g., any applicable rating metric such as a high/low, numerical rating, token based rating, etc.), a number of user ratings for the application, a number and/or frequency of comments associated with the application, a revenue, or the like. Essentially, the observed visibility of an application may correspond to the actual public facing exposure that an application has. The visibility rank of an application may be based on an observed visibility associated with the application. An observed visibility for an application may be directly proportional to a visibility rank associated with the application such that a higher observed visibility of an application may correspond to a higher visibility rank for the application.

As an example of an observed visibility of an application, the observed visibility for the application may be derived from the number of times an application has been viewed in an online application market. An application A may have a higher observed visibility than an application B if application A has been selected for viewing within the online application market a higher number of times than application B. As another example of an observed visibility of an application, the observed visibility for the application may be derived from the frequency at which the application is exposed. An application C may have a first observed visibility of 4 based on 4 installations of instances of the application onto user devices during a first day. The observed visibility of the application may be modified to 400 based on 400 installations of instances of the application onto user devise during a second day.

According to an implementation of the disclosed subject matter, a probabilistic visibility of an application may correspond to a probability that the application will be exposed to the public or a subset of the public. The probability may be influenced by factors such as inclusion in any promotional or visible sections of the market place such as a generic recommended list, a top chart (e.g., within a category that is associated with the application), a personalized recommendation (e.g., based on a user or a group associated with a user), a catalog promotion (e.g., a promotion such as via an advertising campaign ran on the online application market, one or more other applications, a website, a tangible promotion, etc.), a cross-sell (e.g., if the application is offered for sale along with another application), or the like. The visibility rank of an application may be based on the probabilistic visibility associated with the application. A probabilistic visibility for an application may be directly proportional to a visibility rank associated with the application such that a higher probabilistic visibility of an application may correspond to a higher visibility rank for the application.

As an example of a probabilistic visibility of an application, the probabilistic visibility of an application may be derived from the presence of an online campaign associated with the application. More specifically, an online retailer R may sell products to consumers via an online website. The retailer R may provide a link for a consumer to download an application D that enables the consumer to make future purchases via the retailer R's applications such that the consumer need not access the website to make the future purchases. The presence of the link and/or frequency of activation of the link may correspond to a higher probabilistic visibility as the public may be more likely to be exposed to the retailer R's application based on the link.

According to an implementation of the disclosed subject matter, a visibility induced by externalities may correspond to market events, social media mentions, a time range, or the like. Market events may be any applicable events that occur that may not have previously occurred or may not have previously been relevant. As an example of a market event, a new hypersonic railway may be available to the public. An application that provides scheduling information for the hypersonic railway may be submitted via an online application market. Accordingly, based on the availability of the railway to the public, the application may be more likely to be viewed and/or installed by users. Social media mentions may correspond to one or more of clicks, shares, likes, suggestions, posts, or the like within a social media platform. As an example of social media mentions, a first application E may be shared by 85 distinct users on a given social media platform whereas a second application F may be shared by 900 distinct users on the same social media platform. Accordingly, the visibility score component based on externalities may be significantly higher for application F when compared to application E. As an example of a time range associated with visibility, an application that suggests venues for a New Year's event may be significantly more likely to receive exposure in December than in February. Notably, external factors may contribute to a visibility rank such that exposure to an application may be more or less likely based on the external factors.

According to an implementation of the disclosed subject matter, the visibility rating may be generated based on the application information provided by a developer such as during submission of the application. The application information may include an application title, application category, application theme, intended application user base, application cost, or the like. Accordingly, the application information may be utilized to generate a visibility rating such as by determining that the application category corresponds to a popular category and that applications associated with the category are more likely to be visible.

According to an implementation of the disclosed subject matter, a risk rank may be generated for an application based on any applicable factor such as a profanity level, a content maturity level, an incompatibility level, a secrecy level, an automatically generated block, or the like. A profanity level for an application may be detected, for example, based on an analysis of the code corresponding to the application. Here, a set of words or terms designated as profanity in one or more languages may be applied to the potential words or terms that may be visible to a user during use of the application. A content maturity level may be detected, for example, based on an analysis of the code corresponding to the application. Alternatively, or in addition, a content maturity level may be detected based on application information provided by a developer. An incompatibility level may be determined based on analysis of the code corresponding to the application such that the analysis may reveal that the code contains bugs, the application is likely to malfunction, or the like. A secrecy level may be determined based on application information provided by the user, categorization of the application (e.g., if the application relates to items or entities that are classified as secret), or an analysis of the code corresponding to the application. An automatically generated block may be generated based on criteria such as a developer block (e.g., a developer that has been previously flagged as a risky developer), a category based block (e.g., financial applications may automatically be categorized as risky), a resource based block (e.g., an application that is likely to usurp a threshold amount of device resources), or the like.

A visibility rank may be determined by a visibility rank generator such as a computer, server, database, or the like and may be local or remote to the application market. Similarly, a risk rank may be determined by a visibility rank generator such as a computer, server, database, or the like and may be local or remote to the application market. According to an implementation, the visibility rank generator and the risk rank generator may be the same generator.

As disclosed herein, a global rank may be generated based on both a visibility rank and a risk rank. The global rank may be a numerical rank, a Boolean rank, a rating, a normalized rank, or the like. As an example of a normalized rank, a raw global rank for an application G may be determined to be 400. The application with the highest raw global rank may be 800. The global rank for application G may be normalized such that the raw global rank for application G (i.e., 400) may be divided by the highest raw global rank 800 to result in a global rank of 0.5.

According to an implementation of the disclosed subject matter, as shown at step 330 in FIG. 3, an application may be placed in a review category based on the global rank associated with the application. A review category may be a null action review category or an application flag review category. A null action review category may correspond to no immediate action required for the application such that the application may either not be reviewed at a current time and/or may be placed in a low priority review order such that resources are not more urgently allocated to reviewing the application. As an example of a null action review category, an application may be submitted to an online application market, provided to the public, and may receive a global rank of 14 on a scale of 0-100 (i.e., the lowest possible global rank may be 0 and the highest may be 100). The threshold for placing an application in an application flag review category may be 20 such that an application with a global rank below 20 may be placed in a null action review category. Accordingly, based on being placed the null action review category, the application may remain available to the public via the online market place and may not be flagged for immediate review.

According to an implementation of the disclosed subject matter, an application may be placed in an application flag review category. An application flag review category may result in one or more of a removal of the application, a functionality test for the application, and/or a quality test for the application. A removal of an application may correspond to removing an application that is available to the public or a subset of the public via an online application market such that the application may no longer be installed on a user device. Additionally, the application may be deactivated such that previously installed instances of the application on user devices may no longer be accessible by a user. A functionality test may correspond to testing the application against crashes, above threshold delays, lags, or the like. For example, an application flagged for a functionality test may be tested with multiple scenarios and the resulting behavior may be recorded and analyzed. A quality test may be an objective or subjective test that measures the actual tasks performed by the application against the tasks that the application claims to perform. For example, a scheduling application that claims to synchronize a user's email with a user's calendar may be tested to determine whether the synchronization meets an acceptable threshold. It will be understood that an application placed in an application flag review category may result in a combination of removal, functionality test, and/or quality test such that, for example, the application may be removed form an online market place and also be placed through a functionality and/or quality test.

According to implementations of the disclosed subject matter, a global rank for an application may be dynamically generated such that the global rank is updated when either a visibility rank or a risk rank is updated. As an example, a visibility rank and/or risk rank may be constantly updated. A visibility rank may be modified based on the release of a new advertising campaign associated with the application. Accordingly, the global rank may be updated based on the modified visibility rank.

According to implementations of the disclosed subject matter, resources may be allocated for an application based on the application's global rank. A resource may be a computational resource such as devices or memory allocated to perform tests on an application. As a specific example, an application with an above threshold global rank, placed in an application flag review category, may be allocated sufficient memory such that a functionality test and quality test are efficiently performed on the application. Alternatively or in addition, a resource may be the queue priority associated with the application such that an application with a higher global rank is given a higher priority than an application with a lower global rank. An application with a higher priority may be reviewed sooner by a reviewer than an application with a lower priority.

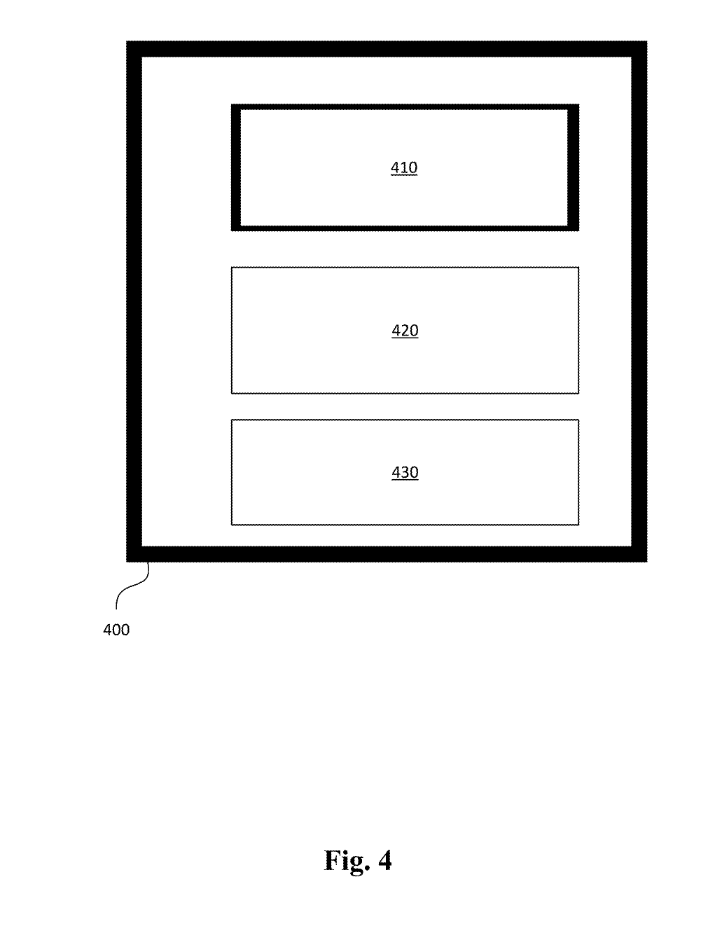

In an illustrative example, as shown in FIG. 4, a reviewer's application review docket 400 may contain three categories: a high priority category 410, a medium priority category 420, and a low priority category 430. Applications with a global rank between 90 and 100 may be placed in the high priority category 410 such that the applications in the high priority category 410 are to be reviewed within 8 hours. An application with a global rank between 50 and 80 may be placed in the medium priority category 420 such that applications in the medium priority category 420 are to be reviewed within 24 hours. An application with a global rank between 0 and 49 may be placed in the low priority category 430 such that applications in the low priority category 420 are to be reviewed as possible (i.e., without urgency).

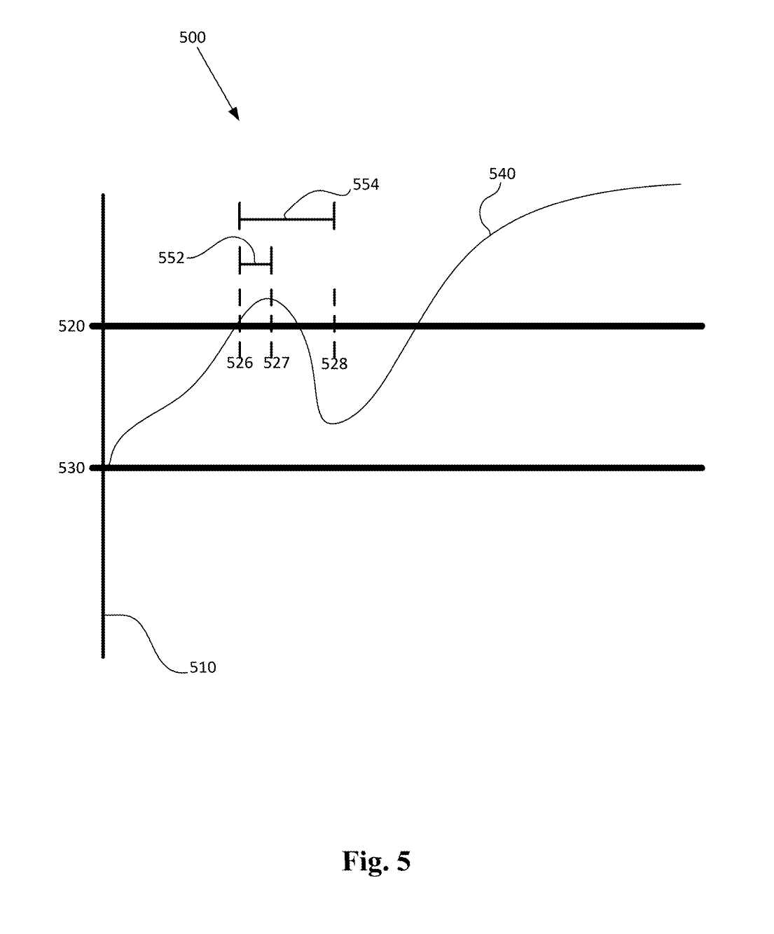

A priority category associated with an application may be modified based on global rank thresholds. The priority categorization may enable efficient use of resources for the application such resources may be made available more readily for a high priority application when compared to a low priority application. As shown in FIG. 5, the y-axis 510 may represent a global rank. global rank high priority threshold may be represented by 520 and global rank medium priority threshold may be represented by 530 such that applications with a global rank 540 above 520 may be high priority applications, applications with a global rank 540 above 530 and below 520 may be medium priority applications, and applications with a global rank 540 below 530 may be low priority applications. According to an implementation of the disclosed subject matter, a buffer threshold may be implemented such that the priority category for an application may be modified if the global rank for the application exceeds a threshold (e.g., the high priority threshold 520, the low priority threshold 530, etc.) for a given amount of time. The buffer threshold may pad against excessive bouncing between priority categories such that, for example, if the global rank for an application fluctuates between 89 and 90, the application is not constantly categorized. As shown in FIG. 5, the x-axis may represent time such that time range 552 represents the time between 526 and 527 and time range 554 represents the time between 526 and 528. As an example, if the buffer threshold is set to the time range 552 then the priority categorization for the application associated with global rank 540 may be modified from a medium priority to a high priority based on the global rank 540 exceeding 520 for a time range larger than that represent by 552. Alternatively, as an example, if the buffer threshold is set to the time range 554 then the priority categorization for the application associated with global rank 540 may not be modified (i.e., the application may remain a medium priority application) based on the global rank 540 not exceeding 520 for a time range larger than that represent by 554.

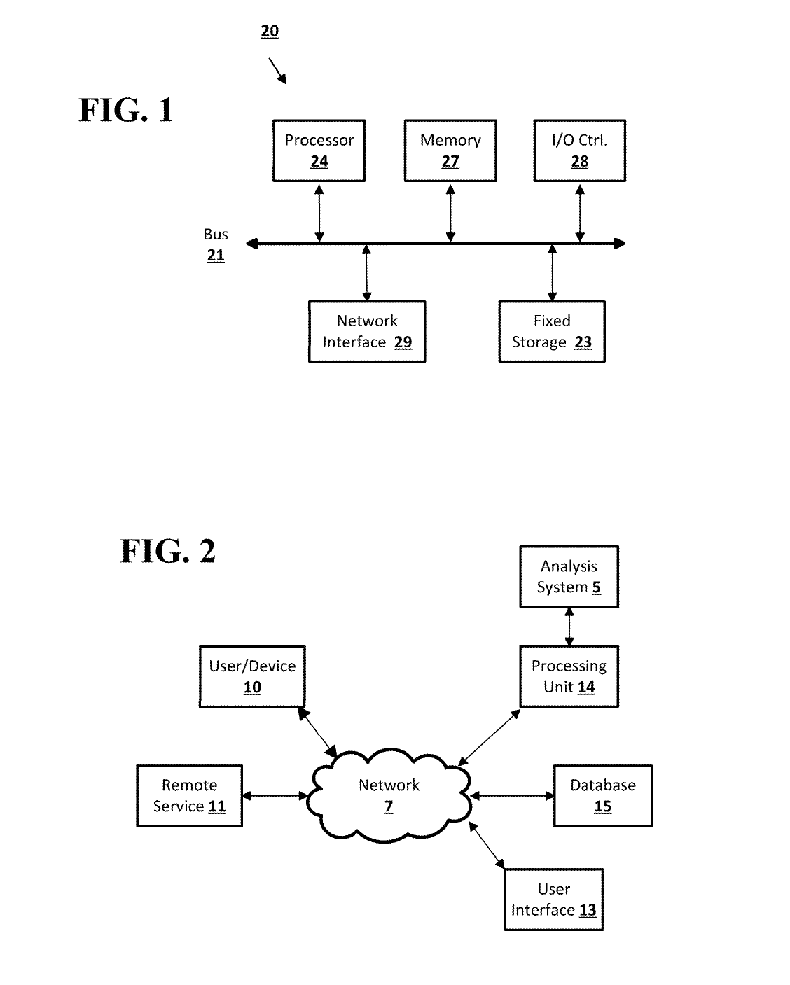

Implementations of the presently disclosed subject matter may be implemented in and used with a variety of component and network architectures. FIG. 1 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 2.

Many other devices or components (not shown) may be connected in a similar manner, such as document scanners, digital cameras, auxiliary, supplemental, or backup systems, or the like. Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 2 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving an application submitted to an application market;
determining a global rank for the application, the global rank based at least on:
a visibility rank;
a risk rank; and
placing the application in a review category based on the global rank.

2. The method of claim 1, wherein the visibility rank corresponds to a probability of exposure, of the application, to a user.

3. The method of claim 1, wherein the visibility rank corresponds to an observed visibility.

4. The method of claim 3, wherein the observed visibility is based on one from the group consisting of: an impression, a velocity, a number of comments, a revenue, and a rating.

5. The method of claim 1, wherein the visibility rank corresponds to a probabilistic visibility.

6. The method of claim 5, wherein the probabilistic visibility is based on one selected from the group consisting of: a campaign presence, a campaign size, a campaign rating, and a current event.

7. The method of claim 1, wherein the visibility rank corresponds to an externality.

8. The method of claim 7, wherein the externality is one selected from the group consisting of: a social media outlet, a media outlet, a news outlet, an aggregation outlet, an entertainment outlet, and an educational outlet.

9. The method of claim 1, wherein the visibility rank is based on application information.

10. The method of claim 1, wherein the risk rank is generated automatically.

11. The method of claim 1, wherein the risk rank is generated based on user input.

12. The method of claim 1, wherein the risk rank is generated based on a factor selected from the group consisting of: a profanity level, a content maturity level, an incompatibility level, a secrecy level, and an automatically generated block.

13. The method of claim 1, wherein the risk rank is based on application information.

14. The method of claim 1, further comprising:
determining the visibility rank by a visibility rank generator; and
determining the risk rank by a risk rank generator.

15. The method of claim 14, wherein the visibility rank generator and the risk rank generator are the same component.

16. The method of claim 1, wherein determining the global rank occurs at a first time and further comprising updating the global rank at a second time.

17. The method of claim 16, wherein updating the global rank at the second time comprises updating one from the group consisting of; the visibility rank, and the risk rank.

18. The method of claim 1, wherein the review category is one selected from the group consisting of: a null action, and an application flag.

19. The method of claim 18, wherein the application flag further comprises taking an action selected from the group consisting of: a removal, a functionality test, and a quality test.

20. The method of claim 1, further comprising allocating a resource based the global rank.

21. The method of claim 20, wherein allocating the resource may correspond to a priority categorization.

22. The method of claim 20, wherein determining the global rank occurs at a first time and further comprising:
updating the global rank at a second time;
determining a change between the global rank at the first time and the global rank at the second time;
determining that the change exceeds a buffer threshold; and
allocating the resource based on determining that the change exceeds a buffer threshold.

23. A system comprising:
a processor, the processor configured to:
receive an application submitted to an application market;
determine a global rank for the application, the global rank based at least on:
a visibility rank;
a risk rank; and
place the application in a review category based on the global rank.

24. The system of claim 23, wherein the visibility rank corresponds to a probability of exposure, of the application, to a user.

25. The system of claim 23, wherein the visibility rank corresponds to an observed visibility.

26. The system of claim 25, wherein the observed visibility is based on one from the group consisting of: an impression, a velocity, a number of comments, a revenue, and a rating.

27. The system of claim 23, wherein the visibility rank corresponds to a probabilistic visibility.

28. The system of claim 27, wherein the probabilistic visibility is based on one selected from the group consisting of: a campaign presence, a campaign size, a campaign rating, and a current event.

29. The system of claim 23, wherein the visibility rank corresponds to an externality.

30. The system of claim 29, wherein the externality is one selected from the group consisting of: a social media outlet, a media outlet, a news outlet, an aggregation outlet, an entertainment outlet, and an educational outlet.

31. The system of claim 23, wherein the visibility rank is based on application information.

32. The system of claim 23, wherein the risk rank is generated automatically.

33. The system of claim 23, wherein the risk rank is generated based on user input.

34. The system of claim 23, wherein the risk rank is generated based on a factor selected from the group consisting of: a profanity level, a content maturity level, an incompatibility level, a secrecy level, and an automatically generated block.

35. The system of claim 23, wherein the risk rank is based on application information.

36. The system of claim 23, wherein determining the global rank occurs at a first time and further comprising updating the global rank at a second time.

37. The system of claim 36, wherein updating the global rank at the second time comprises updating one from the group consisting of; the visibility rank, and the risk rank.

38. The system of claim 23, wherein the review category is one selected from the group consisting of: a null action, and an application flag.

39. The system of claim 38, wherein the application flag further comprises taking an action selected from the group consisting of: a removal, a functionality test, and a quality test.

40. The system of claim 23, further configured to allocate a resource based the global rank.

41. The system of claim 40, wherein allocating the resource may correspond to a priority categorization.

42. The system of claim 40, wherein determining the global rank occurs at a first time and further comprising:
updating the global rank at a second time;
determining a change between the global rank at the first time and the global rank at the second time;
determining that the change exceeds a buffer threshold; and
allocating the resource based on determining that the change exceeds a buffer threshold.
